(19) United States
(12) Patent Application Publication
(10) Pub. No.: US 2018/0176817 A1
(43) Pub. Date: Jun. 21, 2018

(54) DATA THROUGHPUT CONTROL IN A MOBILE WIRELESS COMMUNICATION ENVIRONMENT

(71) Applicants: Anpeng Huang, Beijing (CN); EMPIRE TECHNOLOGY DEVELOPMENT LLC, Wilmington, DE (US)

(72) Inventor: Anpeng Huang, Beijing (CN)

(73) Assignee: EMPIRE TECHNOLOGY DEVELOPMENT LLC, Wilmington, DE (US)

(21) Appl. No.: 15/510,260

(22) PCT Filed: Sep. 11, 2014
(86) PCT No.: PCT/CN2014/086285

§ 371 Date: Mar. 10, 2017

(51) Int. Cl. H04W 28/02; H04W 28/12; H04W 28/22

(52) U.S. Cl. CPC H04W 28/0278; H04W 28/22; H04W 28/12; H04W 28/0252

(57) ABSTRACT

Techniques generally described are related to a method to adjust data transmission from a core network to a base station. The method may include measuring, by the base station, a first air-interface data rate for transmission of mobile data to a mobile device during a first transmission period. The method may include estimating, by the base station based on the first air-interface data rate, a second air-interface data rate for transmission of the mobile data to the mobile device during a second transmission period subsequent to the first transmission period. The method may further include generating, by the base station, a first threshold and a second threshold for a cache based on the second air-interface data rate.

### BACKGROUND

Unless otherwise indicated herein, the materials described in this section are not prior art to the claims in this application and are not admitted to be prior art by inclusion in this section.

To satisfy the growing needs of mobile communication, modern mobile communication technologies may utilize various approaches to achieve performance enhancement. For example, a 3^{rd} generation (3G) or a Code Division Multiple Access (CDMA) mobile communication protocol may be Circuit Switched (CS)-based. In comparison, a 4th generation (4G) Long-Term Evolution (LTE) mobile communication protocol may be exclusively Packet Switched (PS)-based. As the PS-based protocol may allow higher throughputs than the CS-based protocol, in the 4G LTE mobile network, all mobile communications may be transmitted using IP packets.

In PS-based communications, when mobile data is transmitted from a core network to a mobile device, the core network may first deliver the mobile data to a base station which is assigned to communicate with the mobile device. The delivered mobile data may be stored in the base station's cache storage space. Afterward, the base station may retrieve the mobile data from its cache storage space and deliver the mobile data to the mobile device. For example, in a 4G LTE mobile network, downstream mobile data may be transmitted from the core network's Serving Gateway (S-GW)'s to a base station (e.g., eNode B)'s cache via a S1 interface. Since the cache space in the base station is limited, when the data transmission throughputs from the core network to the base station is higher than the data transmission throughputs from the base station to the mobile device, the cache in the base station may be filled with mobile data that cannot be timely delivered, resulting in cache overflowing. On the other hand, when the data transmission throughputs from the core network to the base station is lower than the data transmission throughputs between the base station and the mobile device, the cache in the base station may become empty. As a result, the downstream communication resources may be under-utilized, thereby lowering the mobile device's Quality of Service (QoS).

### SUMMARY

In accordance with some embodiments of the present disclosure, a method to adjust data transmission from a core network to a base station may include measuring, by the base station, a first air-interface data rate for transmission of mobile data to a mobile device during a first transmission period. The method may include estimating, by the base station based on the first air-interface data rate, a second air-interface data rate for transmission of the mobile data to the mobile device during a second transmission period subsequent to the first transmission period. The method may further include generating, by the base station, a first threshold and a second threshold for a cache based on the second air-interface data rate, wherein the cache is configured to store the mobile data received from the core network and to be transmitted to the mobile device, and the first threshold is lower than the second threshold; and upon a determination that a cache usage level of the cache is below the first threshold, transmitting, by the base station to the core network, a first instruction to increase transmission of the mobile data from the core network to the base station.

In accordance with further embodiments of the present disclosure, a throughput control system to adjust data transmission from a core network to a base station may be disclosed. The system may include a cache configured to store mobile data received from the core network and to be transmitted to a mobile device. The system may further include a throughput manager coupled with the cache. The throughput manager may contain a statistic module configured to measure a first air-interface data rate for transmission of the mobile data to the mobile device during a first transmission period. The throughput manager may also contain a prediction module configured to estimate, based on the first air-interface data rate, a second air-interface data rate for transmission of the mobile data to the mobile device during a second transmission period subsequent to the first transmission period. The throughput manager may further contain a control module configured to generate a first threshold and a second threshold for the cache based on the second air-interface data rate, and upon a determination that a cache usage level of the cache is below the first threshold, transmit to the core network a first instruction to increase a core interface data rate for transmission of the mobile data from the core network to the base station.

In accordance with additional embodiments of the present disclosure, a non-transitory computer-readable storage medium may have a set of computer-readable instructions stored thereon which, when executed by a processor, cause the processor to perform a method to adjust data transmission from a core network to a base station. The method may include measuring, by the base station, a first air-interface data rate for transmission of mobile data to a mobile device during a first transmission period. The method may also include estimating, by the base station based on the first air-interface data rate, a second air-interface data rate for transmission of the mobile data to the mobile device during a second transmission period subsequent to the first transmission period. The method may further include generating, by the base station, a first threshold and a second threshold for a cache based on the second air-interface data rate, wherein the cache is configured to store the mobile data received from the core network and to be transmitted to the mobile device, and the first threshold is lower than the second threshold; and upon a determination that a cache usage level of the cache is below the first threshold, transmitting, by the base station to the core network, a first instruction to increase transmission of the mobile data from the core network to the base station.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 shows a block diagram of an embodiment of a mobile communication environment configured to control data communication throughput;

FIG. 2 shows illustrative scenarios in which a base station may be configured to adjust the throughput of data transmission from a core network;

FIG. 3 shows a flow diagram of an illustrative embodiment of a process to adjust the throughput of data transmission from a core network to a base station;

FIG. 4 shows an illustrative embodiment of an example computer program product; and

FIG. 5 shows a block diagram of an illustrative embodiment of an example computer system, all arranged in accordance to at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. The aspects of the present disclosure, as generally described herein, and illustrated in the Figures, can be arranged, substituted, combined, and designed in a wide variety of different configurations, all of which are explicitly contemplated herein.

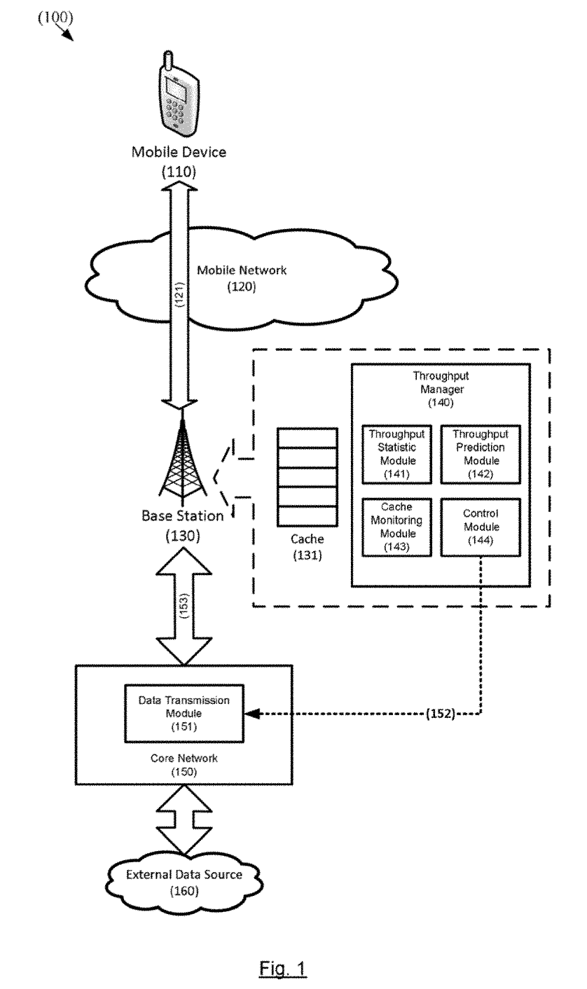

FIG. 1 shows a block diagram of an embodiment of a mobile communication environment configured to control data communication throughput, in accordance to at least some embodiments of the present disclosure. In FIG. 1, a mobile device 110 may be configured to communicate with a base station 130 via a mobile network 120. The base station 130 may be configured to communicate with a core network 150, which in turn may interact with an external data source 160. The mobile device 110, which may be a computing device such as a mobile phone, smartphone, personal digital assistant (PDA), or pager, may be configured to communicate in mobile and wireless means via the mobile network 120 for voice and data communications. The mobile device 110 may also be referred to as a mobile station (MS), Terminal Equipment (TE), Terminal Adapter (TA), Subscriber Identity Module (SMI), or User Equipment (UE). Thus, the mobile device 110 may support network services such as text messaging, email, Internet access, short-range wireless communications (e.g., WIFI and Bluetooth®), in addition to having other general computing capabilities.

In some embodiments, the mobile network 120 (or cellular network) may be a wireless network distributed over a large geographic area in order to support a large number of mobile devices 110. The mobile network 120 may be formed by multiple “cells”, each of which is served by at least one fixed-location base station 130. The multiple cells may joint together and form the mobile network 120 that can provide radio coverage over the large geographic area. Thus, the mobile network 120 may also be referred to as a radio access network (RAN). The mobile network 120 may utilize various cellular technologies such as, without limitations, Global System for Mobile Communications (GSM), Code Division Multiple Access (CDMA), and Universal Mobile Telecommunications System (UMTS). The mobile network 120 may further support 4G mobile telecommunications technologies such as WiMAX® or LTE.

In some embodiments, the base station 130 may be a fix-location transceiver configured to support wireless communications with the mobile device 110. The base station 130, which may be connected to the core network 150 via wired or wireless connections, may also serve as a router in routing data between the mobile device 110 and the core network 150. The base station 130 may optionally utilize another base station 130 (not shown in FIG. 1) to communicate with the core network 150. Alternatively, one or more routers (not shown in FIG. 1) may deliver the network messages between the base station 130 and the core network 150. In a 3G wireless communication scheme, the base station 130 may be referred to as a “Node B.” In a 4G LTE wireless communication scheme, the base station 130 may be an “eNode B.”

In some embodiments, the core network 150 may be an aggregation of various backbone services in a telecommunication network. The core network 150 may provide authentication, call control/switching, data charging, service invocation, and gateway services. For example, in a 3G wireless communication scheme, the core network 150 (e.g., GSM core network), which may be CS or PS based, may contain Mobile Switching Center (MSC), Home Location Register (HLR), Authentication Center (AuC), Visitor location register (VLR), Equipment Identity Register (EIR), UMTS Terrestrial Radio Access Network (UTRAN) and other various functions and components. In a 4G LTE wireless communication scheme, the core network 150 (e.g., SAE Core network), which may be PS based, may contain Mobility Management Entity (MME), Serving Gateway (SGW), PDN Gateway (PGW), Home Subscriber Server (HSS), and other various functions and components. The 4G core network 150 may utilize its SGW to communicate with a base station 130 (eNode B), and utilize its PGW to connect to an external data source 160. In some embodiments, the external data source 160 may be an Internet-based data source or any data source that can provide user requested data.

In some embodiments, during operation, the mobile device 110 may communicate with a particular active base station 130 using radio waves to transmit data signals. In other words, the mobile device 110 may utilize an “air interface” 121, which is a radio-based communication link, to communicate with the base station 130. For example, in GSM communication scheme, an air interface 121 may be implemented using the UMTS Terrestrial Radio Access (UTRA) standard. Further, an “air-interface data rate” may refer to a rate of data throughput for a particular air interface 121. Thus, the performance of wireless communication between the mobile device 110 and the base station 130 may be quantified and compared using the “air-interface data rate.” In comparison, the base station 130 may communicate with the core network 150 using multiple interfaces that are not radio-based communication links. For convenience purposes, these non-radio-based communication links may be referred to as “core network interface” 153. For example, the core network interface may be a “MME-eNode B” interface for communications between the base station 130 and the MME of the core network 150. Further, the “core-interface data rate” may refer to a rate of data throughputs between a particular base station 130 and the core network 150.

In some embodiments, for convenience purposes, data that are transmitted and received by the mobile device 110 may be referred to as “mobile data.” The mobile device 110 may transmit a “data request” to the base station 130, requesting a specific piece of mobile data from the external data source 160. The data request may first be delivered to the base station 130 via the air interface 121, and then transmitted to the core network 150 for processing. The above data transmission path (mobile device 110 to base station 130 to core network 150) may be referred to as an “upstream” data transmission path. Once received the data request, the core network 150 may process the data request, and retrieve the requested mobile data from the external data source 160. Afterward, the core network 150 may transmit the retrieved mobile data to the base station 130 using a “core network interface” 153.

In some embodiments, the base station 130 may be configured with a cache 131 and a throughput manager 140. The cache 131 (or buffer) may be a storage mechanism configured to temporarily store mobile data received from the core network 150. Afterward, the base station 130 may deliver the mobile data in the cache 131 to the designated mobile device 110. This data transmission path (core network 150 to base station 130 to mobile device 110) may be referred to as a “downstream” data transmission path. Further, the core network 150 may divide the mobile data into multiple data packets, and transmits these data packets sequentially, non-sequentially, and/or in-parallel to the base station 130. Once some of the data packets are delivered to the base station 130 and stored in the cache 131, the base station 130 may in turn transmit the data packets in the cache 131 to the mobile device 110, and remove these transmitted data packets from the cache 131. The base station 130 may continuously receive additional data packets from the core network 150, store them into the cache 131, and transmit some of the data packets in the cache 131 to the mobile device, until all data packets requested by the mobile device 110 are delivered.

In some embodiments, the “air-interface data rate” for communications between the base station 130 and the mobile device 110 may be higher than the “core-interface data rate” for communications between the base station 130 and the core network 150. This may be caused by a slow communication link between the base station 130 and the mobile device 110. In this situation, if the communication throughput between the core network 150 and the base station 130 is not adjusted, the cache 131 in the base station 130 may be quickly filled-up or overflew, resulting in data loss and data redelivery. In another situation, the base station 130's “air-interface data rate” may be lower than the “core-interface data rate.” This may be caused by the core network 150 under heavy usage, resulting less data packets being delivered to the base stations. In this case, if the communication throughput between the core network 150 and the base station 130 is not adjusted, the cache 131 in the base station 130 may be quickly dried up, resulting in wasting of air-interface resource between the base station 130 and the mobile device 110.

In some embodiments, the base station 130 may be configured with a throughput manager 140, which may be a software or hardware module installed in the base station 130. The throughput manager 140 may be configured to manage and adjust the throughput of the core network interface 153 based on the “air-interface data rate” and the current cache usage level of the cache 131. Specifically, the throughput manager 140 may contain, among other components and modules, a throughput statistic module 141, a throughput prediction module 142, a cache monitoring module 143, and a control module 144.

In some embodiments, the throughput statistic module 141 may be configured to continuously detect and determine the “air-interface data rate” 121 between the base station 130 and the mobile devices 110 that are communicating with the base station 130. Specifically, the throughput statistic module 141 may mark a specific transmission period, and monitor the mobile data that has been transmitted between the base station 130 and the mobile device 110 during this specific transmission period. Once the transmission period ends, the throughput statistic module 141 may calculate an “air-interface data rate” for the specific transmission period by dividing the total amount of the transmitted mobile data with the specific transmission period. The throughput statistic module 141 may also store the “air-interface data rates” collected from previous transmission periods.

In some embodiments, the throughput prediction module 142 may be configured to predict an “air-interface data rate” for an upcoming transmission period. The throughput prediction module 142 may determine a calculated value (e.g., an average value, a weighted average value) based on the historical “air-interface data rates” collected by the throughput statistic module 141 from the previous transmission periods. Afterward, the throughput prediction module 142 may generate the predicted “air-interface data rate” for the upcoming transmission period based on this calculated value. In some embodiments, the cache monitoring module 143 may be configured to monitor the current status of the cache 131. Specifically, the cache monitoring module 143 may determine a current “cache usage level” based on the amount of data stored in the cache 131.

In one embodiment, the control module 144 may be configured to generate a first threshold and a second threshold for the cache 131, based on the capacity of the cache 131 and the predicted “air-interface data rate” provided by the throughput prediction module 142. Afterward, the control module 144 may obtain the current cache usage level from the cache monitoring module 143, and compare the current cache usage level with the first threshold and the second threshold. Based on the outcome of the comparison, the control module 144 may transmit an instruction (152) to a data transmission module 151 of the core network 150. The data transmission module 151 may be configured to adjust the throughput of the core network interface 153 accordingly. The details of the above functionalities are further described below.

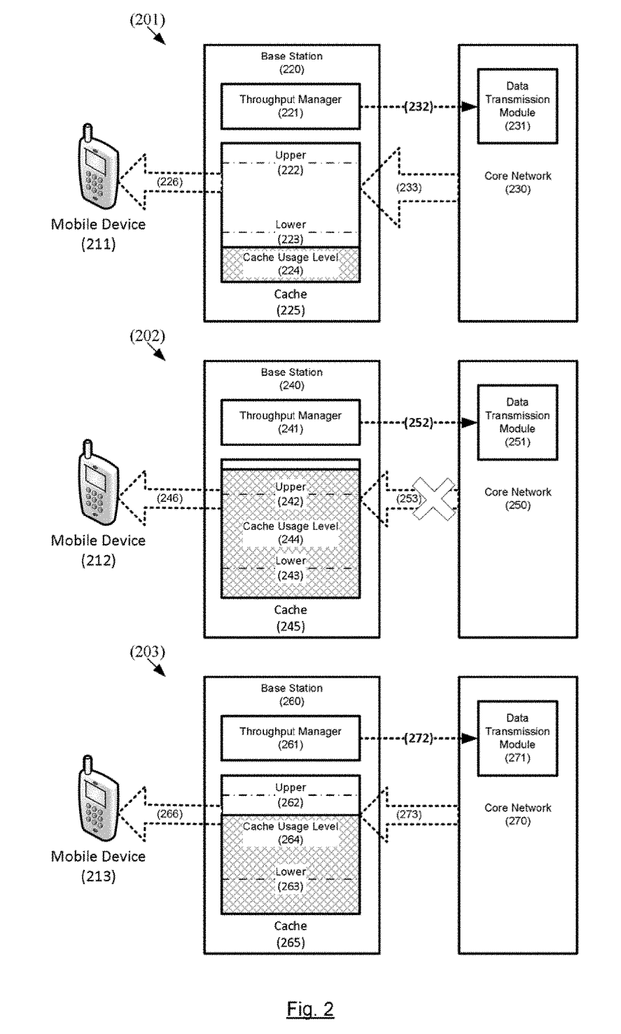

FIG. 2 shows illustrative scenarios in which a base station may be configured to adjust the throughput of data transmission from a core network, in accordance to at least some embodiments of the present disclosure. In FIG. 2, mobile devices 211, 212, and 213 may be similar to the mobile device 110 of FIG. 1. The mobile devices 211, 212, and 213 may be configured to communicate with base stations 220, 240, and 260 (each of which is similar to the base station 130 of FIG. 1), respectively. The base station 220, 240, and 260 may communicate with core networks 230, 250, and 270 (each of which is similar to the core network 150 of FIG. 1). Each of the base stations 220, 240, and 260 may be configured with a cache (e.g., caches 225, 245, and 265, similar to the cache 131 of FIG. 1) and a throughput manager (e.g., throughput managers 221, 241, and 261, similar to the throughput manager 140 of FIG. 1).

In some embodiments, mobile device 211 may transmit a data request to the base station 220, requesting for a piece of mobile data from the core network 230. In response to the data request, the core network 230 may be configured to retrieve and deliver the requested mobile data via the core network interface 233 to the base station 220. The base station 230 may be configured to store the delivered mobile data in the cache 225, before transmitting the stored mobile data via the air-interface 226 to the mobile device 211. In the meantime, the throughput manager 211 may monitor the “air-interface data rates” of the air-interface 226 during previous transmission periods, and predict an “air-interface data rate” for transmitting the mobile data stored in the cache 225 to the mobile device 211. The throughput manager 211 may also determine an upper threshold 222 and a lower threshold 223 for the cache 225, based on the predicted “air-interface data rate” and the current cache usage level in the cache 225.

In scenario 201, the base station 220 may be in the process of receiving some of the data packets for the mobile data from the core network 230, storing the received data packets into the cache 225, and transmitting some of the other data packets in the cache 225 to the mobile device 211. The throughput manager 221 may also continuously monitor the current cache usage level 224 in the cache 225. In some embodiments, the upper threshold 222, the lower threshold 223, and the cache usage level 224 may be a percentage value based on the total storage capacity of the cache 225. For example, the upper threshold 222 may have a value “80%”, meaning that when higher than 80% of the cache 225 is occupied, the cache 225 may be deemed heavily occupied. Likewise, the lower threshold 223 may have a value “20%”, meaning that when lower than 20% of the cache 225 is used for storing data, the cache 225 may be considered insufficiently occupied. The throughput manager 221 may generate a percentage value based on the amount of data that are currently stored in the cache 225 and the total storage capacity of the cache 225. Afterward, the throughput manager 221 may assign the percentage value (e.g., 15%) as the cache usage level 224, which may be meaningfully compared with the upper threshold 222 and the lower threshold 223. Alternatively, the throughput manager 221 may utilize storage capacity values (e.g., in megabytes) to set up the upper threshold 222, the lower threshold 223, and the cache usage level 224 for determining the occupancy status of the cache 225.

In some embodiments, the throughput manager 221 may determine that the cache usage level 224 of the cache 225 is below the lower threshold 223. In this case, the throughput manager 221 may transmit an instruction 232 to the data transmission module 231 of the core network 230, instructing the core network 230 to increase the throughput of the core network interface 233 in transmitting mobile data from the core network 230 to the base station 220. Upon receiving the instruction 232, the data transmission module 231 may increase the “core-interface data rate” for delivering the remaining data packets of the mobile data to the base station 220. In other words, the throughput manager 221 may instruct the core network 230 to increase the “core-interface data rate” between the core network 230 and the base station 220 from its current value to a higher value, in order to prevent the cache 225 from becoming empty. In the meantime, the base station 220 may continue delivering through the air-interface 226 the data packets in the cache 225 to the mobile device 211.

In some embodiments, the scenario 202 may show the outcome of the above throughput adjustment scenario 201 after a certain period of increasing the “core-interface data rate.” Thus, the mobile device 212, the base station 240, the core network 250, as well as the associated components contained therein may correspond to the mobile device 211, the base station 220, the core network 230 and their associated components contained therein, respectively. In scenario 202, the cache usage level 244 in the cache 245 may be much higher than the cache usage level 224 in the cache 225, due to the core network 270's delivering of a larger amount of data packets to the cache 245 than the amount of data packets the base station 240 transmitted from the cache 245 to the mobile device 212.

In some embodiments, the throughput manager 241 may continuously monitor the cache usage level 244 of the cache 245. Upon a determination that the cache usage level 244 is above the upper threshold 242, the throughput manager 241 may issue a second instruction 252 to the data transmission module 251 of the core network 250. The second instruction 252 may instruct the data transmission module 251 to decrease or stop the transmission of the data packets from the core network 250 to the base station 240. In other words, the throughput manager 241 may instruct the core network 230 to decrease the “core-interface data rate” from its current rate, in order to allow the data packets in the cache 225 to be delivered to the mobile device 211.

In some embodiments, the scenario 203 may show the outcome of the above throughput adjustment after a certain period of reduced/stopped delivering of the data packets from the core network 230 to the base station 220. Thus, the mobile device 213, the base station 260, the core network 270, as well as the associated components contained therein may correspond to the mobile device 212, the base station 240, the core network 250 and their associated components contained therein, respectively. In scenario 203, the cache usage level 264 in the cache 265 may be lower than the cache usage level 244 in the cache 245, as the core network 270 may delivered a reduced amount, or stopped the transmission, of the remaining data packets to the base station 260. In other words, the cache usage level 264 may indicate that the core network 270 may transmit at a lower amount of data packets to the cache 265 of the base station 260 than the base station 260's delivering of the data packets from the cache 265 to the mobile device 213 during the last several transmission periods.

In some embodiments, the throughput manager 261 may determine that the cache usage level 264 is between the upper threshold 262 and the lower threshold 263. In this case, the throughput manager 261 may either maintain the current core interface data rate 273 by not issuing any adjustment instruction, or issue a resume instruction 272, to the data transmission module 271 of the core network 270. Specifically, when the previous second instruction 252 is to stop the transmitting of the data packets, the throughput manager 261 may issue the third instruction 272 to resume the throughput of the core-interface 273 to a predetermined throughput rate. Alternatively, when the previous second instruction 252 is to reduce the “core-interface data rate” 253, then the throughput manager 261 may issue the third instruction 272 to slightly increase the data rate of the core-interface 273. Further, the throughput manager 261 may not issue any instruction to the data transmission module 271, when the cache usage level 264 in the cache 265 is maintained between the upper threshold 262 and the lower threshold 263. In this case, the core network 270 may maintain the current throughputs of the core-interface 273, since it does not receive any adjustment instruction from the throughput manager 261. Thus, the throughput manager 261 may be configured to issue instructions to the core network 270 that can increase or decrease the throughputs of, or even stop and resume, the transmission from the core network 270 to the base station 260, all based on the upper threshold 262, the lower threshold 263, and the cache usage level 264. The details on how the throughput manager 261 determines the upper threshold 262 and the lower threshold 263 for the cache 265 based on a predicted “air-interface data rate” and the storage capacity of the cache 265 are further described below.

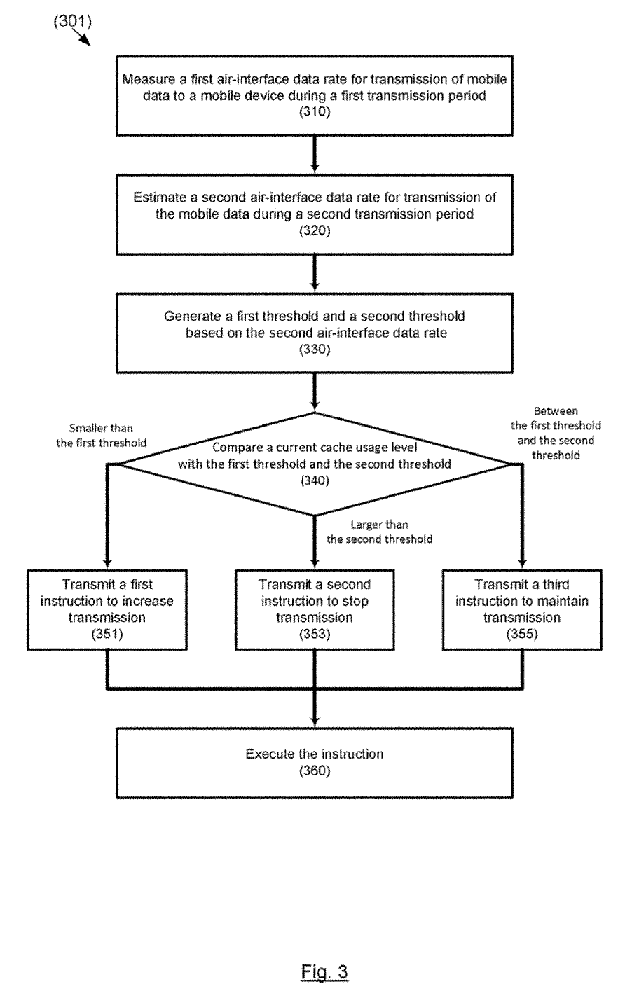

FIG. 3 shows a flow diagram of an illustrative embodiment of a process to adjust the throughput of data transmission from a core network to a base station, in accordance to at least some embodiments of the present disclosure. The process 301 may include one or more operations, functions, or actions as illustrated by blocks 310, 320, 330, 340, 351, 353, 355, and 360, which may be performed by hardware, software and/or firmware. The various blocks are not intended to be limiting to the described embodiments. For example, for this and other processes and methods disclosed herein, the operations performed in the processes and methods may be implemented in differing order.

Furthermore, the outlined operations in FIG. 3 and/or otherwise shown and described elsewhere herein are provided as examples, and some of the operations may be optional, combined into fewer operations, supplemented with other operations, or expanded into additional operations without detracting from the essence of the disclosed embodiments. Although the blocks are illustrated in a sequential order, these blocks may also be performed in parallel, and/or in a different order than those described herein. In some embodiments, machine-executable instructions for the process 301 or other process(es) described herein may be stored in memory or other tangible non-transitory computer-readable storage medium, executed by a processor, and/or implemented in a multi-core compilation system.

At block 310 (“Measure a first air-interface data rate for transmission of user data to a mobile device during a first transmission period”), a base station may be configured to communicate with a mobile device over a mobile network. The base station (or the throughput statistic module of the base station) may be configured to monitor the “air-interface data rate” of the mobile communication between the mobile device and the base station. Specifically, the base station may monitor the downstream (from the base station to the mobile device) “air-interface data rate” during a specific transmission period. For example, the base station may determine the first “air-interface data rate” by calculating an average data rate during the km transmission period. In other words, the base station may track the total amount of downstream data being transmitted from the base station to the mobile device during the km transmission period, and divide the total amount of downstream data by the amount of time in the km transmission period. The determined first air-interface data rate may be denoted as
Thr(Tₖ), in which Tₖ may refer to the kₜₕ transmission period.

At block 320 (“Estimate a second air-interface data rate for transmission of the user data during a second transmission period”), the base station (or the throughput prediction module of the base station) may be configured to predict/estimate a “second air-interface data rate” for the transmission of the user data to the mobile device during a second transmission period. The second transmission period may be any transmission period subsequent to the first transmission period. The estimated second air-interface data rate may be denoted as
˜Thr(Tₖ₊₁), in which Tₖ₊₁ may refer to the (K+1)ₜₕ transmission period.

In some embodiments, the base station may estimate the second air-interface data rate based on the first air-interface data rate. For example, the base station may utilize the value of the first air-interface data rate as the value for the second air-interface data rate. Alternatively, the base station may measure multiple air-interface data rates from those transmission periods that are prior to the second transmission period, similar to the measuring of the first air-interface data rate as described above. Afterward, the base station may calculate an average of the multiple air-interface data rates as the value of the second air-interface data rate.

In some embodiments, the base station may calculate a weighted average of the multiple air-interface data rates as the estimated second air-interface data rate. Specifically, the weighted average ˜Thr(Tₖ₊₁) may be calculated based on the following equation:

˜Thr(Tₖ₊₁)=p*Thr(Tₖ)+(1−p)*Thr(Tₖ₋₁), wherein 0<p<1. Equation (1)

Afterward, the base station may assign the weighted average value to the second air-interface data rate. Further, the base station may estimate the second air-interface data rate by using a linear recursion value that is determined based on the multiple air-interface data rates. Specifically, the linear recursion value may be calculated based on the following equation:

˜Thr(Tₖ₊₁)=2*Thr(Tₖ)−Thr(Tₖ₋₁). Equation (2)

At block 330 (“Generate a first threshold and a second threshold based on the second air-interface data rate”), the base station may generate a first threshold (e.g., a lower threshold) and a second threshold (e.g. an upper threshold) for the cache, based on the estimated second air-interface data rate. Specifically, the base station (or the control module of the base station) may generate the lower threshold by applying a first adjustment factor to the second air-interface data rate. The first adjustment factor may be determined based on a data transmission throughput (e.g., core interface data rate) between the core network and the base station. Thus, the first threshold, which may be denoted using C_{lower} with the first adjustment factor denoted using A, may be shown using the following equation:

C_{lower}=λ*˜Thr(Tₖ₊₁)*T, where 0<λ<1. Equation (3)

In other words, the base station may multiply the second air-interface data rate ˜Thr(Tₖ₊₁) with the amount of time Tin the second transmission period. Afterward, the base station may multiply the adjustment factor A with the above generated value, resulting a storage capacity value (e.g., megabytes) for C_{lower}. Thus, once the cache contains less data than the C_{lower}, then there is a high possibility that the remaining data packets in the cache may be delivered to the mobile device before additional data packets are transmitted from the core network to the base station. Such a scenario may exhaust the cache and cause the base station to await for additional data from the core network.

In some embodiments, the adjustment factor A may be fine-tuned based on the real-time core-interface data rate between the base station and the core network. As described above, when the cache usage level in the cache is below the first threshold, the base station may transmit an instruction to increase the core-interface data rate. However, it may take times for the base station to generate the instruction and transmit the instruction to the core network. Further, it may take additional times for the core network to process the instruction, and perform operations to increase the core-interface data rate. Thus, the adjustment factor A may be increased or decreased to make sure that during the above instruction transmission and processing time, there are sufficient amount of data in the cache to be transmitted to the mobile device before the cache becomes empty. For example, the adjustment factor A may have an initial value of 0.2. When the base station notices that the cache contains less and less data, it may increase this adjustment factor in order to prevent the wasting of precious air-interface resources and the data interruption in the mobile device.

In some embodiments, the base station may generate the second threshold based on the cache's storage capacity and the second air-interface data rate. Specifically, the base station may generate a first value by applying a second adjustment factor to the second air-interface data rate, and generate a second value by applying a third adjustment factor to the cache's storage capacity. Afterward, the base station may select either the first value or the second value as the value for the second threshold.

In some embodiments, the second threshold (“upper threshold”), which may be denoted using Cᵤₚₚₑᵣ, may be shown using the following equation:

Cᵤₚₚₑᵣ=Min{η*˜Thr(Tₖ₊₁)*T, φ*C_{cache}}, η>1, λ<φ<1 Equation (4)

Specifically, ˜Thr(Tₖ₊₁) refers to the second air-interface data rate; C_{cache} refers to the capacity of the cache; η refers to the second adjustment factor applicable to the second air-interface data rate; and φ refers to the third adjustment factor applicable to the C_{cache}. Thus, the above first value (“air-interface based value”) may be η*˜Thr(Tₖ₊₁)*T. The above second value (“cache-capacity based value”) may be φ*C_{cache}. And the upper threshold may be determined by selecting the smaller one of the “air-interface based value” and the “cache-capacity based value.”

In other words, the base station may generate the “air-interface based value” by multiplying the second air-interface data rate ˜Thr(Tₖ₊₁) with the amount of time T in the second transmission period and the second adjustment factor η. Since the amount of data to be transmitted during the second transmission period (“estimated transmission amount”) may be calculated as ˜Thr(Tₖ₊₁)*T, once the cache contains more data than this “estimated transmission amount,” there may be extra data left after the second transmission period. Thus, a value that is larger than the “estimated transmission amount” may be selected as the upper threshold. As a result, the base station may apply a larger-than-one adjustment factor η to the “estimated transmission amount” to generate the above “air-interface based value.”

In some embodiments, when the cache usage level in the cache is above the “air-interface based value”, the base station may transmit an instruction to reduce the core-interface data rate or stop the transmission from the core network. However, it may take times for the base station to generate the instruction and transmit the instruction to the core network. Further, it may take additional times for the core network to process the instruction, and perform operations to reduce or stop. Thus, the second adjustment factor η may be set to a value (e.g., 1.5) in order to take the above instruction transmission and processing time into consideration.

In some embodiments, the base station may generate the “cache-capacity based value” as an alternative to the “air-interface based value.” Specifically, the base station may multiple the cache storage capacity C_{cache} with the third adjustment factor φ. The adjustment factor φ may be set to a less-than-one but larger than A value (e.g., 0.8) in order to take the above instruction transmission and processing time into consideration.

In some embodiments, when the “air-interface based value” is larger than the “cache-capacity based value”, the base station may determine that the cache is close to full. In this case, in order to prevent data overflow in the cache, the base station may select the smaller “cache-capacity based value” as the upper threshold. Alternatively, when the “air-interface based value” is smaller than the “cache-capacity based value”, the base station may determine that the estimated air-interface data rate is too low. If a large amount of data in the cache cannot be timely transmitted to the mobile device, some of the data remain in the cache may become stale. Thus, the base station may set the upper threshold using the lower “air-interface based value.” In other words, the base station may select the smaller one of the “air-interface based value” or the “cache-capacity based value.”

At block 340 (“Compare a current cache usage level with the first threshold and the second threshold”), the base station may evaluate the current cache usage level, and compare it with the first threshold and the second threshold. When the current cache usage level is smaller than the first threshold, the process 301 may proceed to block 351. When the current cache usage level is larger than the second threshold, the process 301 may proceed to block 353. Further, when the current cache usage level is between the first threshold and the second threshold, the process 301 may proceed to block 355.

At block 351 (“Transmit a first instruction to increase transmission”), upon a determination that the cache usage level is smaller than the second threshold, the base station may transmit a first instruction to the core network, requesting the core network to increase transmission of the mobile data from the core network to the base station. In some embodiments, the first instruction may contain command such as “Cache Data Required.” Once the core network received the first instruction, it may either start to deliver mobile data to the base station, or increase the “core interface data rate” for transmitting the mobile data to the base station.

At block 353 (“Transmit a second instruction to stop transmission”), upon a determination that the cache usage level is larger than the second threshold, the base station may transmit a second instruction to the core network, requesting the core network to stop/pause the transmission of mobile data to the base station. In some embodiments, the second instruction may contain command such as “Cache Data Rejected.” Once the core network received the second instruction, it may stop to deliver mobile data to the base station. Alternatively, the second instruction may request to reduce the transmission of the mobile data to the base station. In this case, the core network may reduce the “core interface data rate” for transmitting the mobile data to the base station accordingly.

At block 355 (“Transmit a third instruction to maintain transmission”), upon a determination that the cache usage level is above the first threshold and below the second threshold, the base station may transmit a third instruction to the core network, requesting the core network to maintain transmission of the mobile data from the core network to the base station. Specifically, the base station may determine that the core network is steadily delivering the mobile data to the base station. In this case, upon receiving the third instruction, the core network may maintain its current “core interface data rate.” Alternatively, the core network is stopped by previous instructions (e.g., the second instruction). In this case, the core network may also maintain its “pause” state. In some embodiments, the third instruction may be an instruction to resume a previously paused transmission. In this case, the core network may resume the transmission of the mobile data to its previous “core interface data rate.”

At block 360, (“Execute the instruction”), the core network may execute the received the first, second, or third instruction accordingly. After completed the above operation during the second transmission period, the base station may measure a third air-interface data rate for transmission of the mobile data to the mobile device during the second transmission period. The base station may then estimating, based on the third air-interface data rate, a fourth air-interface data rate for transmission of the mobile data to the mobile device during a third transmission period subsequent to the second transmission period. Afterward, the base station may adjust the first threshold and the second threshold for the cache based on the fourth air-interface data rate. Thus, the base station is configured to continuously adjust and readjust the first threshold and the second threshold based on the real-time measured air-interface data rate and the estimated air-interface data rate.

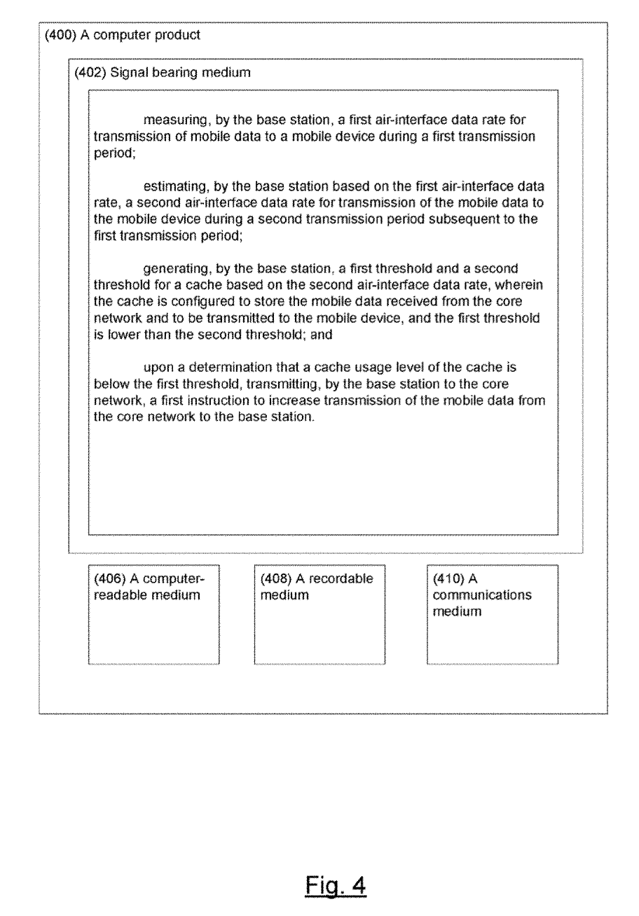

FIG. 4 is a block diagram of an illustrative embodiment of a computer program product 400 to implement a method to adjust data transmission from a core network to a base station. Computer program product 400 may include a signal bearing medium 402. Signal bearing medium 402 may include one or more sets of executable instructions 404 stored thereon that, in response to execution by, for example, a processor, may provide the features and operations described above. Thus, for example, referring to FIG. 1, the base station 130 may undertake one or more of the operations shown in at least FIG. 3 in response to the instructions 404.

In some implementations, signal bearing medium 402 may encompass a non-transitory computer readable medium 406, such as, but not limited to, a hard disk drive, a Compact Disc (CD), a Digital Versatile Disk (DVD), a digital tape, memory, etc. In some implementations, signal bearing medium 402 may encompass a recordable medium 408, such as, but not limited to, memory, read/write (R/W) CDs, R/W DVDs, etc. In some implementations, signal bearing medium 402 may encompass a communications medium 410, such as, but not limited to, a digital and/or an analog communication medium (e.g., a fiber optic cable, a waveguide, a wired communications link, a wireless communication link, etc.). Thus, for example, referring to FIG. 1, computer program product 400 may be wirelessly conveyed to the base station 130 by signal bearing medium 402, where signal bearing medium 402 is conveyed by communications medium 410 (e.g., a wireless communications medium conforming with the IEEE 802.11 standard). Computer program product 400 may be recorded on non-transitory computer readable medium 406 or another similar recordable medium 408.

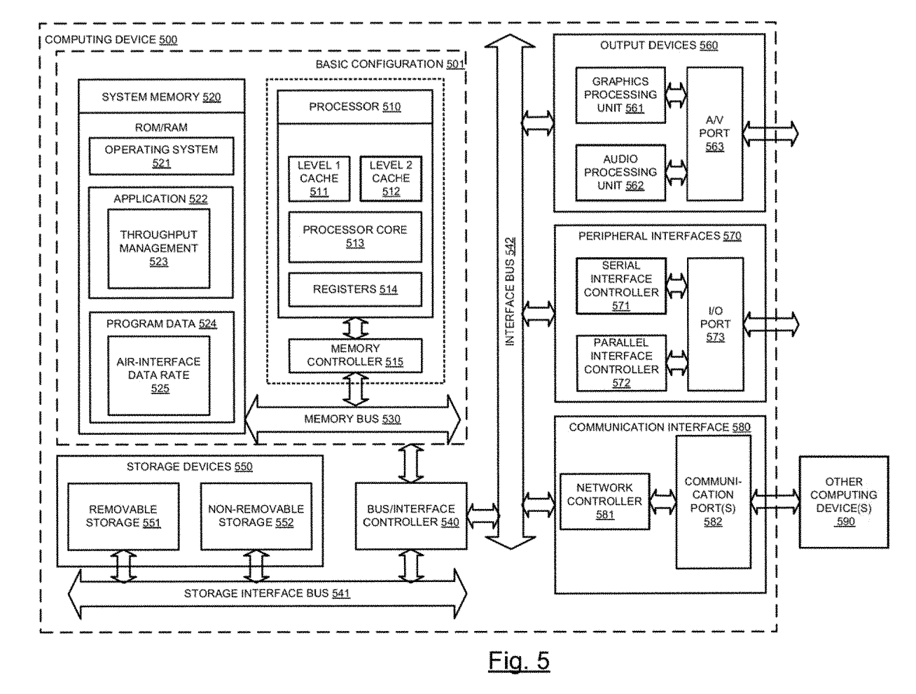

FIG. 5 shows a block diagram of an illustrative embodiment of an example computer system 500. In a very basic configuration 501, the computer system 500 may include one or more processors 510 and a system memory 520. A memory bus 530 may be used to communicate between the processor 510 and the system memory 520.

Depending on the desired configuration, processor 510 may be of any type including but not limited to a microprocessor (μP), a microcontroller (μC), a digital signal processor (DSP), or any combination thereof. Processor 510 can include one or more levels of caching, such as a level one cache 511 and a level two cache 512, a processor core 513, and registers 514. The processor core 513 can include an arithmetic logic unit (ALU), a floating point unit (FPU), a digital signal processing core (DSP Core), or any combination thereof. In one embodiment, the base station 130 (such as shown in FIG. 1) may be implemented by the processor 510. The cores 171, 172, etc of the heterogeneous multi-core processor 170 (such as shown in FIG. 1) may each be implemented by individual ones of a plurality of the processor core 513. A memory controller 515 can also be used with the processor 510, or in some implementations the memory controller 515 can be an internal part of the processor 510.

Depending on the desired configuration, the system memory 520 may be of any type including but not limited to volatile memory (such as RAM), non-volatile memory (such as ROM, flash memory, etc.) or any combination thereof. The system memory 520 may include an operating system 521, one or more applications 522, and program data 524. The application 522 may include a throughput management application 523 that is arranged to perform the operations as described herein including at least the operations described with respect to the process 301 of FIG. 3 and/or described elsewhere in this disclosure. The program data 524 may include air-interface data rate 525 to be accessed by the throughput management application 523, and/or may include other objects, code, data, instructions, etc. as described herein. In some embodiments, the throughput manager 140 of FIG. 1 may be implemented as the application 522 to operate with the program data 524 on the operating system 521. Specifically, the throughput manager 140 may generate the instruction set 525 based on a set of source code. This described basic configuration is illustrated in FIG. 5 by those components within dashed line 501.

Computing device 500 may have additional features or functionality, and additional interfaces to facilitate communications between basic configuration 501 and any required devices and interfaces. For example, a bus/interface controller 540 may be used to facilitate communications between basic configuration 501 and one or more data storage devices 550 via a storage interface bus 541. Data storage devices 550 may be removable storage devices 551, non-removable storage devices 552, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

System memory 520, removable storage devices 551, and non-removable storage devices 552 are examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which may be used to store the desired information and which may be accessed by computing device 500. Any such computer storage media may be part of computing device 500.

Computing device 500 may also include an interface bus 542 to facilitate communication from various interface devices (e.g., output devices 560, peripheral interfaces 570, and communication devices 580) to basic configuration 501 via bus/interface controller 540. Example output devices 560 include a graphics processing unit 561 and an audio processing unit 562, which may be configured to communicate to various external devices such as a display or speakers via one or more A/V ports 563. Example peripheral interfaces 570 include a serial interface controller 571 or a parallel interface controller 572, which may be configured to communicate with external devices such as input devices (e.g., keyboard, mouse, pen, voice input device, touch input device, etc.) or other peripheral devices (e.g., printer, scanner, etc.) via one or more I/O ports 573. An example communication device 580 includes a network controller 581, which may be arranged to facilitate communications with one or more other computing devices 590 over a network communication link via one or more communication ports 582. In some implementations, computing device 500 includes a multi-core processor, which may communicate with the host processor 510 through the interface bus 542.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 500 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 500 may also be implemented as a personal computer including both laptop computer and non-laptop computer configurations.

The use of hardware or software may be generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

In some embodiments, a method for controlling the flow of transmission between a core network and a base station comprises determining a wireless transmission rate, the base station buffer status, and optionally other parameters. The flow rate between the core network and one or more base stations may be controlled so that the data volume in the buffer of the base station, and e.g. user equipment service data volume transmitted to the base station are adjustable to achieve a buffer status that improves overall system performance. In some examples, upper and lower buffer thresholds for a time period may be initially set according to an estimated an air interface transmission rate, and subsequently the rate of transmission from a user device may be adjusted to maintain the data volume in the buffer such that data loss and inefficiencies are avoided.

In some embodiments, a base station may be configured to set and dynamically adjust the upper and lower thresholds of the base station buffer, based on the buffer capacity and the air interface real-time transmission capability of the base station, and to timely adjust the downlink service data volume transmitted by the core network to the base station according to the status of the base station buffer. The data volume stored in the base station buffer may be adjusted to prevent the base station buffer from being oversaturated to overflow, or the downlink data packets from waiting so long in the buffer as to cause overtime packet loss, and also avoids a hungry state of the base station buffer which may causes idleness, a waste of radio resources, or transmission interruption of user downlink data packets.

In some embodiments, upper and lower thresholds of the buffer may be adjusted based on an air interface transmission rate. A based station may be configured to measure the air interface transmission rate for a time period, and then estimate an estimated air interface transmission rate for the next time period. The base station may further be configured to set the thresholds of the buffer (e.g. upper and lower thresholds) based on the estimated air interface transmission rate. The base station may be further configured to monitor the buffer status, for example estimating a current buffer status in relation to the set thresholds. The buffer status may be monitored substantially continuously. The base station may be further configured to send a service instruction command to the core network based on the estimated current buffer status. The base station may provide measurements and estimations in substantially real time, allowing buffer threshold adjustments, service command instructions, and the like to be provided in response to a dynamically changing environment.

Some embodiments include apparatus and/or methods useful for mobile electronic device communication, such as mobile internet device communication, including web browsing service protocols such as HTTP. A HTTP service may be divided into multiple data groups, with each data packet comprising multiple data packets. When a data group request arrives, the data packets will be generated and transmitted together. Some embodiments allow improved flow control of such packet data. In some embodiments, methods may appreciably reduce the overheads of frequent instruction commands between the base station and the core network, and thus allow a decrease in the core network's frequent starting/stopping of downlink data packet transmission, enhancing the stability of the system. A real-time flow control such as described in examples herein may be used between the core network and the base station buffer, to allow the data volume stored in the base station buffer to reach at least an approximately and possibly substantially optimal state, wherein the buffer is neither oversaturated to cause overflow, nor in a hungry state to cause waste of radio resources. Some embodiments include apparatus and methods used by LTE (long-term evolution) system equipment, user equipment (such as smartphones and the like), LTE system operators, LTE network planning and optimization service providers, and other telecommunication systems, user equipment, other equipment, and operators.

In some embodiments, an example base station may comprise a setting unit, a measurement unit, a calculation and estimation unit, a judging unit, and an instruction command generating and sending unit. In some embodiments, the setting unit, the measurement unit, the calculation and estimation unit, the judging unit, and the instruction command generating and sending unit are provided by the base station, for example by an electronic circuit such as an electronic circuit comprising a processor and associated components, and a data transmission executing unit is provided by the core network. A setting unit may be used to set the period for the base station to measure the air interface throughput, and determine the upper and lower thresholds of the buffer status based on the throughput measurement(s). A measurement unit may be used to measure the base station's own air interface transmission rate in the time period, which may be determined as the total data transmitted via the air interface by the base station in the time period, divided by the time period to obtain a data transmission rate. A calculation and estimation unit may be used to calculate and/or estimate the air interface transmission rate of the base station for the next time period (e.g. a subsequent and/or following time period), and use the estimated throughput for the next period to calculate the upper and lower thresholds of the buffer. The calculation and estimation unit may output the calculated upper/lower thresholds of the buffer to the setting unit, which may set the buffer thresholds to the corresponding values. A judging unit may be used by the base station to dynamically monitor the buffer status, and according to the upper/lower thresholds output by the setting unit, to estimate the buffer status and determine whether the remaining data volume in the buffer has reached the upper or lower threshold. An instruction command generating and sending unit may be used by the base station, according to the result output by the judging unit, to generate a corresponding instruction command, and send the instruction command to the core network. A data transmission executing unit may be provided by the core network, and configured such that the core network starts, stops or maintains the transmission of downlink data packets to the base station, according to the instruction command of the base station received by the data transmission executing unit.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples can be implemented, individually and/or collectively, by a wide range of hardware, software, firmware, or virtually any combination thereof. In some embodiments, several portions of the subject matter described herein may be implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware are possible in light of this disclosure. In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to”, etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, various embodiments of the present disclosure have been described herein for purposes of illustration, and various modifications may be made without departing from the scope and spirit of the present disclosure. Accordingly, the various embodiments disclosed herein are not intended to be limiting, with the true scope and spirit being indicated by the following claims.

1. A method to adjust data transmission from a core network to a base station, the method comprising:
measuring, by the base station, a first air-interface data rate for transmission of mobile data to a mobile device during a first transmission period;
estimating, by the base station based on the first air-interface data rate, a second air-interface data rate for transmission of the mobile data to the mobile device during a second transmission period subsequent to the first transmission period;
generating, by the base station, a first threshold and a second threshold for a cache based on the second air-interface data rate, wherein the cache is configured to store the mobile data received from the core network and to be transmitted to the mobile device, and the first threshold is lower than the second threshold; and
upon a determination that a cache usage level of the cache is below the first threshold, transmitting, by the base station to the core network, a first instruction to increase transmission of the mobile data from the core network to the base station.

2. The method of claim 1, wherein in response to the first instruction, the core network is configured to increase, a data transmission throughput between the core network and the base station.

3. The method of claim 1, further comprising:
upon a determination that the cache usage level is above the second threshold, transmitting, by the base station to the core network, a second instruction to pause the transmission of the mobile data from the core network to the base station.

4. The method of claim 3, further comprising:
upon a determination that the cache usage level is decreased below the second threshold, transmitting, by the base station to the core network, a third instruction to resume the transmission of the mobile data from the core network to the base station.

5. The method of claim 1, further comprising:
upon a determination that the cache usage level is above the first threshold and below the second threshold, transmitting, by the base station to the core network, a third instruction to maintain the transmission of the mobile data from the core network to the base station.

6. The method of claim 1, further comprising:
measuring a third air-interface data rate for the transmission of the mobile data to the mobile device during the second transmission period;
estimating, based on the third air-interface data rate, a fourth air-interface data rate for transmission of the mobile data to the mobile device during a third transmission period subsequent to the second transmission period; and
adjusting the first threshold and the second threshold for the cache based on the fourth air-interface data rate.

7. The method of claim 1, wherein estimating the second air-interface data rate comprises:
collecting a plurality of air-interface data rates from a plurality of transmission periods prior to the second transmission period; and
determining the estimated second air-interface data rate based on an average of the plurality of air-interface data rates.

8. The method of claim 1, wherein generating, the first threshold and the second threshold comprises:
generating the first threshold by an application of a first adjustment factor to the second air-interface data rate; and
generating the second threshold based on storage capacity of the cache and the second air-interface data rate.

9. The method of claim 8, wherein the first adjustment factor is determined based on a data transmission throughput between the core network and the base station.

10. The method of claim 8, wherein generating the second threshold comprises:
generating a first value by applying a second adjustment factor to the second air-interface data rate;
generating a second value by applying a third adjustment factor to the storage capacity of the cache; and
generating the second threshold by selecting a smaller one of the first value and the second value.

11. The method of claim 10, wherein the second and the third adjustment factors are determined based on a data transmission throughput between the base station, the mobile device and the second air-interface data rate.

12. A throughput control system to adjust data transmission from a core network to a base station, the system comprising:
a cache configured to store mobile data received from the core network and to be transmitted to a mobile device; and
a throughput manager coupled with the cache, wherein the throughput manager contains:
a statistic module configured to measure a first air-interface data rate for transmission of the mobile data to the mobile device during a first transmission period;
a prediction module configured to estimate, based on the first air-interface data rate, a second air-interface data rate for transmission of the mobile data to the mobile device during a second transmission period subsequent to the first transmission period; and
a control module configured to generate a first threshold and a second threshold for the cache based on the second air-interface data rate, and upon a determination that a cache usage level of the cache is below the first threshold, transmit to the core network a first instruction to increase a core interface data rate for transmission of the mobile data from the core network to the base station.

13. The system as recited in claim 12, wherein the throughput manager further contains:
a cache monitoring module configured to continuously monitor the cache and determine the cache usage level.

14. The system as recited in claim 12, wherein the control module is further configured to,
upon a determination that the cache usage level is above the second threshold, transmit to the core network a second instruction to reduce the core interface data rate for the transmission of the mobile data from the core network to the base station.

15. The system as recited in claim 12, wherein the control module is further configured to:
upon a determination that the cache usage level is above the first threshold and below the second threshold, transmit to the core network a third instruction to maintain the core interface data rate for the transmission of the mobile data from the core network to the base station.

16. The system as recited in claim 12, wherein the control module is further configured to generate the first threshold and the second threshold by:
generating the first threshold by an application of an adjustment factor to the second air-interface data rate; and
generating the second threshold based on the storage capacity of the cache and the second air-interface data rate.

17. A non-transitory computer-readable storage medium, including a set of computer-readable instructions stored thereon which, in response to execution by a processor, cause the processor to perform a method to adjust data transmission from a core network to a base station, the method comprising:
measuring, by the base station, a first air-interface data rate for transmission of mobile data to a mobile device during a first transmission period;
estimating, by the base station based on the first air-interface data rate, a second air-interface data rate for transmission of the mobile data to the mobile device during a second transmission period subsequent to the first transmission period;
generating, by the base station, a first threshold and a second threshold for a cache based on the second air-interface data rate, wherein the cache is configured to store the mobile data received from the core network and to be transmitted to the mobile device, and the first threshold is lower than the second threshold; and
upon a determination that a cache usage level of the cache is below the first threshold, transmitting, by the base station to the core network, a first instruction to increase transmission of the mobile data from the core network to the base station.

18. The non-transitory computer-readable storage medium as recited in claim 17, wherein the method further comprises:
upon a determination that the cache usage level is above the second threshold, transmitting, by the base station to the core network, a second instruction to pause the transmission of the mobile data from the core network to the base station.

19. The non-transitory computer-readable storage medium as recited in claim 18, wherein the method further comprises;
upon a determination that the cache usage level is decreased below the second threshold, transmitting, by the base station to the core network, a third instruction to resume the transmission of the mobile data from the core network to the base station.

20. The non-transitory computer-readable storage medium as recited in claim 17, wherein the method further comprises:
upon a determination that the cache usage level is above the first threshold and below the second threshold, transmitting, by the base station to the core network, a third instruction to maintain the transmission of the mobile data from the core network to the base station.
